(19) United States
(12) Patent Application Publication
(10) Pub. No.: US 2026/0244139 A1
(43) Pub. Date: Aug. 20, 2026

(54) IMAGE FORMING SYSTEM, METHOD FOR CONTROLLING IMAGE FORMING SYSTEM, AND NON-TRANSITORY COMPUTER-READABLE STORAGE MEDIUM

(71) Applicant: Konica Minolta, Inc., Tokyo (JP)

(72) Inventors: Fuhito NAKAGAWA, Tokyo (JP); Yasushi TSUE, Tokyo (JP); Shinya SAITO, Tokyo (JP)

(21) Appl. No.: 19/543,496

(22) Filed: Feb. 18, 2026

(30) Foreign Application Priority Data
Feb. 20, 2025 (JP) 2025-025638

(51) Int. Cl. G03G 15/00; G03G 15/16; G03G 15/20

(52) U.S. Cl. CPC G03G 15/5029; G03G 15/161; G03G 15/205; G03G 15/2064; G03G 2215/00742

(57) ABSTRACT

The image forming system includes an image former and a hardware processor. The image former forms an image on a sheet. The hardware processor controls image formation by the image former on the basis of the attribute of a recording medium. The image forming system has a first mode in which control based on a change in the attribute of the recording medium is performed and a second mode in which the control based on a change in the attribute of the recording medium is not performed, in a case where image formation on a first recording medium having a first attribute and image formation on a second recording medium having a second attribute different from the first attribute are continuously performed.

### CROSS-REFERENCE TO RELATED APPLICATION

Japanese patent application No. 2025-025638 filed on Feb. 20, 2025, including description, claims, drawings, and abstract the entire disclosure is incorporated herein by reference in its entirety.

### BACKGROUND OF THE INVENTION

### 1. Technical Field

The present invention relates to an image forming system, a method for controlling the image forming system, and a non-transitory computer-readable storage medium storing a control program.

### 2. Description of Related Art

In recent years, business to consumer (B to C) transactions through electronic commerce (EC) sites have tended to increase. A product purchased through an EC site is packed in a cardboard box or the like or enclosed in an envelope or the like in a distribution center and delivered to a consumer (orderer). At this time, a printed matter such as a leaflet related to the product is often sent together with the product.

At present, an operator picks up necessary leaflets from leaflets printed in advance in a printing company or the like and stored in a large amount in a warehouse of a distribution center in accordance with an instruction of an EC company, and stacks the leaflets in a designated order to manually create a set of leaflets. The created set of flyers is bundled or enclosed together with the product at the time of shipment of the product.

Such a set of flyers is, for example, created by a worker in advance in his/her spare time for each product purchased by a customer or for each number of purchases, and is stored for each product in many boxes arranged on a predetermined shelf. A set of flyers is picked from the shelf by the worker when the set of flyers is bundled with a product. Creating a set of flyers in advance facilitates the picking work performed by the worker, but if the set of flyers to be bundled with the product is changed due to the flyers having limited-time information, the worker needs to recreate the set of flyers. Further, when a set of leaflets to be packed together is changed, a leaflet which cannot be used has to be discarded. Further, when there are flyers that can be still used, a space for storing such flyers is required.

In addition, the schedule of shipping work for products in the logistics center is managed, and in order to avoid storage of surplus flyers generated due to a delay of the work, it is necessary to generate printed materials such as flyers according to the schedule. However, there are products that need to be delivered on the day, and it is difficult to accurately predict the number of products and the number of flyers to be handled in one day.

In this connection, Japanese Unexamined Patent Publication No. 2010-257054 discloses performing a shipping operation using printed matter printed by a printer when the number of copies in stock in a stock shelf that manages the stock of printed matter is less than the number of copies ordered.

### SUMMARY OF THE INVENTION

The technique disclosed in Japanese Unexamined Patent Application Publication No. 2010-257054 makes it possible to compensate for the shortage of the printed materials in the stock shelf by using the printed materials printed by the printer, but does not consider the schedule of the shipping work for products. Therefore, in a case where the supply of the printed materials printed by the printer is delayed, the shipping work for the product and the printed material may also be delayed.

The present invention has been made in view of the above-mentioned circumstances. An object of the present invention is to provide an image forming system, a method for controlling the image forming system, and a non-transitory computer-readable storage medium storing a control program with which it is possible to shorten the time to generate a printed material to be sent together with a product.

To achieve at least one of the abovementioned objects, according to an aspect of the present invention, an image forming system reflecting one aspect of the present invention comprises the followings.

The image forming system includes an image former that forms an image on a recording medium and a hardware processor. The hardware processor controls image formation by the image former on the basis of the attribute of the recording medium. The image forming system has a first mode in which control based on a change in the attribute of the recording medium is performed and a second mode in which the control based on a change in the attribute of the recording medium is not performed, in a case where image formation on a first recording medium having a first attribute and image formation on a second recording medium having a second attribute different from the first attribute are continuously performed.

### BRIEF DESCRIPTION OF THE DRAWINGS

Advantages and features provided by one or more embodiments of the present invention will be more fully understood from the following detailed description and the accompanying drawings, which are for purposes of illustration only and are not intended to define the limits of the invention.

FIG. 1 is a schematic block diagram illustrating the configuration of an electronic commerce system according to a first embodiment;

FIG. 2 is a schematic block diagram illustrating the configuration of an image forming system illustrated in FIG. 1;

FIG. 3 is a schematic block diagram illustrating the configuration of a print information acquirer illustrated in FIG. 2;

FIG. 4 is a schematic diagram illustrating composition setting information;

FIG. 5 is a schematic block diagram illustrating the configuration of a document data generator illustrated in FIG. 2;

FIG. 6 is a schematic block diagram illustrating the configuration of a print job generator illustrated in FIG. 2;

FIG. 7 is a configuration diagram illustrating the configuration of an image forming apparatus illustrated in FIG. 1;

FIG. 8 is a schematic block diagram illustrating the configuration of the image forming apparatus illustrated in FIG. 1;

FIG. 9 is a schematic block diagram illustrating the configuration of a controller illustrated in FIG. 8;

FIG. 10 is a flowchart illustrating the procedure of a method for printing a flyer in the image forming system according to the first embodiment;

FIG. 11 is a schematic diagram illustrating an operation of continuously printing images on sheets having different widths when a cleaning operation is on;

FIG. 12 is a schematic diagram illustrating an operation of continuously printing images on sheets having different widths when the cleaning operation is off;

FIG. 13 is a schematic diagram illustrating a pattern table of a flyer to be bundled with a product;

FIG. 14 is a schematic diagram illustrating, as a comparative example, a shelf on which many boxes for storing flyers are arranged;

FIG. 15 is a flowchart illustrating the procedure of a method for printing a flyer in an image forming system according to a second embodiment;

FIG. 16 is a schematic diagram illustrating an operation of continuously printing images on sheets of different types (basis weights) in a fixing temperature control ON mode; and

FIG. 17 is a schematic diagram illustrating an operation of continuously printing images on sheets of different types (basis weights) in a fixing temperature control OFF mode.

### DETAILED DESCRIPTION

Hereinafter, embodiments of the present invention will be described with reference to the drawings. It is to be noted that the scope of the present invention is not limited to the disclosed embodiments. In the description of the drawings, the same components are denoted by the same reference signs, and the redundant description is omitted. In addition, dimensional ratios in the drawings are exaggerated for convenience of description and may be different from actual ratios.

### First Embodiment

### (Example of Electronic Commerce System)

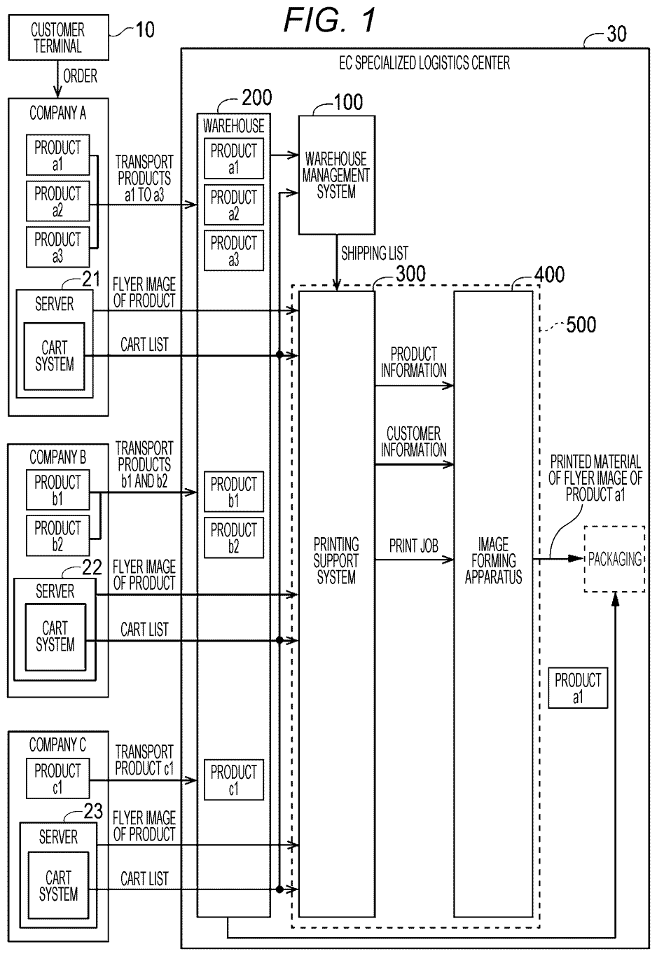

FIG. 1 is a schematic block diagram illustrating the configuration of an electronic commerce (EC) system according to a first embodiment. In this EC system, a customer (orderer) uses a customer terminal 10 to order a product from a company A, a company B, or a company C as an EC company. FIG. 1 illustrates a case where an order is placed with the company A from the customer terminal 10. In a case where the customer orders products from the company B and the company C, the orders are similarly placed with the company B and the company C, although this is not illustrated.

An order for a product is placed through a cart system installed in each of company A, company B, and company C. The drawing illustrates a case where the products of the company A are a1 to a3, the products of the company B are b1 and b2, and the product of the company C is c1. It should be noted that FIG. 1 does not illustrate the quantity of inventory of each product.

The EC-specialized distribution center 30 is a distribution center specialized for EC. The inventory of the products of each company in a warehouse 200 is managed by a warehouse management system 100. The products are transported from the companies A, B, and C to the EC specialized logistics center 30 according to the remaining number of the products, and are supplied to the warehouse 200.

The EC specialized logistics center 30 is provided with the warehouse management system 100, the warehouse 200, a printing support system 300, and an image forming apparatus 400 as constituent elements of the EC system. The warehouse management system 100 and the printing support system 300 may be implemented by an on-premise server (computer) or may be implemented by a cloud server.

When a product is ordered by the customer, a picking list is output from the image forming apparatus 400 in response to the order in the EC specialized logistics center 30. The picking list is also referred to as a shipping instruction, and is a list including information (for example, a storage location of a product, a product code, a quantity, and the like) necessary for the picking work by a worker. The worker who is in charge of shipping the product checks the picking list, picks the product stored in the product storage area of the warehouse 200, acquires a printed material of a flyer image of the product, inspects the product and the printed material, and then packs the product together with the printed material in a cardboard box. Note that the product may be picked using a machine (e.g., material handling). Furthermore, the flyer image of the product is not limited to the flyer of the ordered product, but includes a flyer image of a product or a service related to the ordered product.

The printed material of the flyer image of the product is ejected onto a sheet ejection tray of the image forming apparatus 400 in accordance with the timing for sending a product by the worker. In addition, the order of ejection of the printed materials by the image forming apparatus 400 corresponds to, for example, the order in which the product is bundled with the printed materials.

The companies A to C which are EC companies are provided with servers 21 to 23 as constituent elements of the EC system, respectively. The cart system is realized by the servers 21 to 23.

The warehouse management system 100, the warehouse 200, the printing support system 300, and the image forming apparatus 400 which are included in the EC specialized logistics center 30, the customer terminal 10, and the servers 21 to 23 of the companies A to C constitute the EC system according to the present embodiment.

### (Customer Terminal 10)

The customer terminal 10 is, for example, a computer such as a personal computer, a smartphone, or a tablet terminal that is used by the customer to order a product. The customer terminal 10 includes input/output devices such as a touch screen, a keyboard, and a mouse (not illustrated). The customer performs operations such as searching for a product, selecting a product that the customer desires to purchase, and determining a payment method, using the input/output device of the customer terminal 10 at, for example, a shopping site provided on the Internet by the EC company.

### (Servers 21 to 23)

The servers 21 to 23 are computers installed in the companies A to C, respectively, and each execute a cart system to output a cart list in response to a customer's order. The cart list includes information regarding the product ordered by the customer, information about the customer such as the name and the address, a pickup request to the warehouse management system 100, and the like. The cart system is a system that provides a mechanism for allowing a customer to order a product and pay for the product on the Internet. In the mechanism provided by the cart system, a customer searches for a product on an EC site or a mail-order website, places the product that the customer wants to purchase in a shopping cart, and performs a purchase procedure to order the product. For the product for which the purchase procedure has been performed, payment is performed with, for example, a credit card. The cart system may have an order reception management function, a customer management function, a product management function, a sales promotion management function, and the like in addition to the cart function and the settlement function. The customer shops using a virtual shopping cart (basket) displayed on the screen of the customer terminal 10. For example, the customer can select a desired product by placing the product in a shopping cart in the same manner as that when the customer shops in a real store.

The servers 21 to 23 generate information regarding the product and information regarding the customer from information that is input when the customer orders the product. In the following, the information regarding a product is also referred to as product information, and the information regarding a customer is also referred to as customer information. The product information includes, for example, information related to a product storage area in the warehouse 200 and a delivery company that delivers the product, in addition to information specific to the product such as the name, the manufacturing number, and the manufacturing date of the product. The customer information includes information such as the customer's name, address, contact information, and the number of purchases for each product.

Furthermore, the servers 21 to 23 transmit a flyer image of a product created in advance by the EC company to the printing support system 300.

### (EC-Specialized Logistics Center 30)

### <Warehouse Management System 100>

The warehouse management system 100 is a WMS (Warehouse Management System), and has functions such as warehousing/delivery management and inventory management of products in the warehouse 200. Upon receiving the shipping instruction, the warehouse management system 100 generates a management number on the basis of the cart list and information acquired from the warehouse 200. The management number is a number managed by the warehouse management system 100 and the cart system in cooperation with each other. The shipping instruction can be generated, for example, on the basis of a shipment request transmitted to the warehouse management system 100 from each cart system when the cart system receives an order from a customer. The shipping request may be included in the cart list, for example. The warehouse management system 100 generates, every several hours to a day, a shipping list in which a management number and an instruction (order) regarding a product to be picked up from the warehouse 200, the quantity of the product, and the like are described, and transmits the generated shipping list to the printing support system 300. The shipment list includes information on shipment timing of the product, such as a shipment date and time.

In the example illustrated in FIG. 1, the warehouse 200 stores therein the products a1 to a3 transported from the company A, the products b1 and b2 transported from the company B, and the product c1 transported from the company C. In the warehouse 200, a sensor for detecting the remaining number of products is arranged, and information regarding the remaining number of products is sequentially transmitted to the warehouse management system 100. For example, when the remaining number of products stored in the warehouse 200 is zero or becomes small, a signal requesting supply of products can be transmitted from the warehouse 200 to the warehouse management system 100.

### <Image Forming System 500>

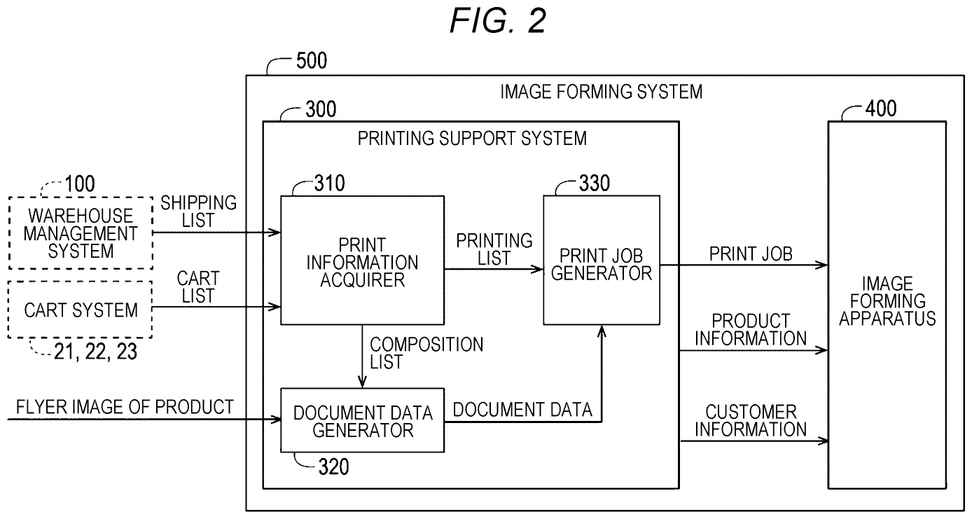

FIG. 2 is a schematic block diagram illustrating the configuration of the image forming system 500 illustrated in FIG. 1. The image forming system 500 is a system that generates a printed material to be sent together with an ordered product. Here, in the present specification, sending the product and the printed matter at the same time means sending the printed matter together with the product in a bundled or enclosed manner. The image forming system 500 includes a printing support system 300 and an image forming apparatus 400.

The image forming system 500 according to the present embodiment has a first mode in which image formation is controlled based on a change in the attribute of a sheet (recording medium), and a second mode in which image formation is not controlled based on a change in the attribute of a sheet. The attribute of the sheet may include, for example, the size, type, basis weight, thickness, and physical property values of the sheet.

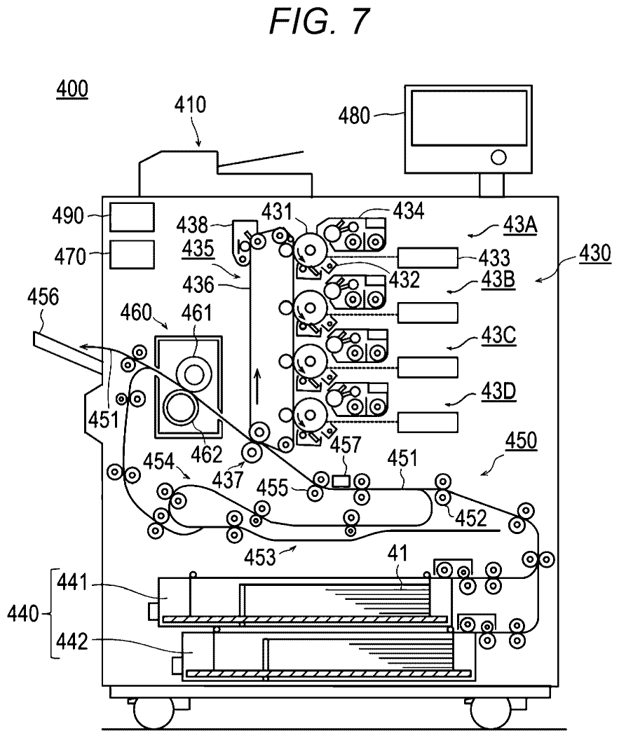

The physical property values include, for example, the surface properties of the sheet. The surface properties of the sheet can be measured by, for example, a media sensor 457 (see FIG. 7) disposed on the sheet conveyance path between a sheet feeder 440 and a transferer 435 of the image forming apparatus 400 to be described later. The media sensor 457 includes a light emitter and a light receiver (not illustrated). The light emitter irradiates the surface of the sheet with light obliquely (e.g., at an incident angle of 75 degree), and the light receiver detects the amounts of specular reflection light and diffuse reflection light from the sheet. The media sensor 457 can measure the surface properties of a sheet on the basis of the absolute value of the intensity of light received by each light receiver and the ratio between the amounts of specular reflection light and diffuse reflection light. The basis weight and the thickness can be obtained from the amount of attenuation of light transmitted through the sheet, and the type of the sheet can be determined from the thickness and the information about the surface properties.

A print job (image forming job) for generating a printed material to be sent together with a product can include formation of an image on a first sheet having a first attribute as the attribute thereof and formation of an image on a second sheet having a second attribute as the attribute thereof. The second attribute is an attribute different from the first attribute.

The image forming system 500 has a plurality of modes including the first mode and the second mode. In the first mode, the image forming system 500 performs control based on a change in the attribute of the sheet in a case where the formation of the image on the first sheet and the formation of the image on the second sheet are continuously performed. On the other hand, in the second mode, the image forming system 500 does not perform the control based on a change in the attribute of the sheet. The first mode can be a mode in which priority is given to the quality of the printed material, and the second mode can be a mode in which priority is given to productivity over the quality of the printed material. A specific example of control of image formation in the image forming system 500 will be described later.

### <Printing Support System 300>

The printing support system 300 is a system for supporting printing by the image forming apparatus 400, and constitutes the image forming system 500 together with the image forming apparatus 400. The printing support system 300 includes a print information acquirer 310, a document data generator 320, and a print job generator 330. The printing support system 300 outputs a print job on the basis of the shipping list, the cart list, and the flyer image of the product.

The printing support system 300 generates a print job for generating a printed material to be sent together with a product in response to a customer's order for the product. When generating a print job, the printing support system 300 can change documents to be used for printing and the order of stacking of the documents with composition. The printing support system 300 starts the processing of generating the print job, for example, at a timing when the shipping list is imported from the warehouse management system 100 to the printing support system 300.

### [Print Information Acquiring Section 310]

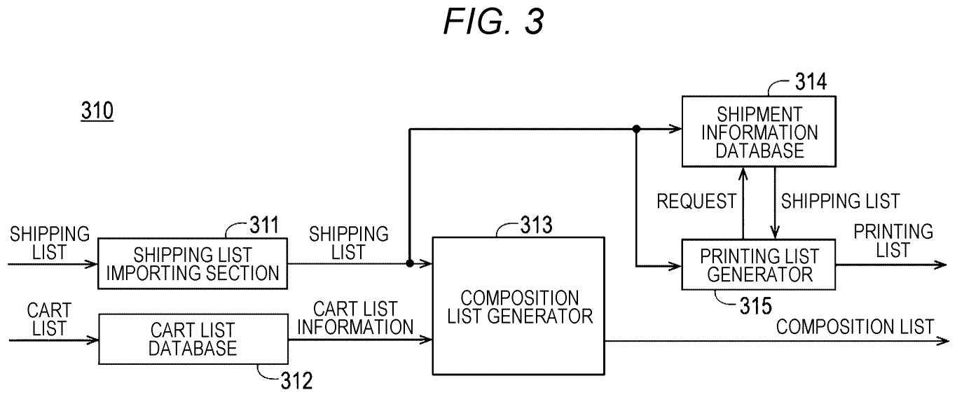

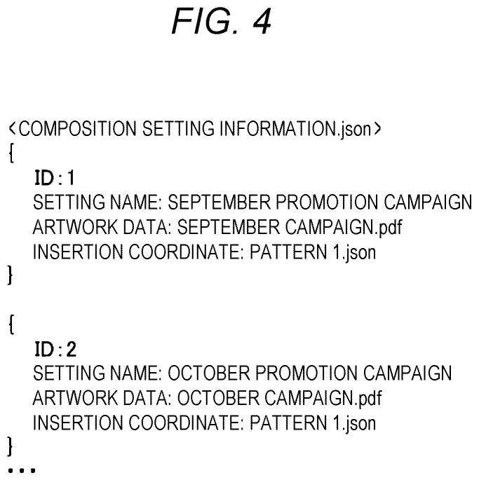

FIG. 3 is a schematic block diagram illustrating the configuration of the print information acquirer 310 illustrated in FIG. 2. FIG. 4 is a schematic diagram illustrating composition setting information. The print information acquirer 310 includes a shipping list importing section 311, a cart list database 312, a composition list generator 313, a shipment information database 314, and a printing list generator 315.

The print information acquirer 310 generates a composition list and a printing list on the basis of the shipping list and the cart list. The composition list is information obtained by combining the customer information included in the cart list with the order described in the shipping list by the management number, and is a list required when the document data is subjected to variable printing. The printing list is a list in which orders to be printed among the orders listed in the shipping list are arranged in the order of printing.

### [Shipping List Importing Section 311]

The shipping list importing section 311 imports the shipping list output from the warehouse management system 100 and outputs the shipping list to the composition list generator 313. The shipping list includes a list of products to be shipped and shipment timing information for each product.

### [Cart List Database 312]

The cart list database 312 stores, in a database, the cart lists input from the cart systems of the companies A to C. In response to a request from the composition list generator 313, the cart list database 312 outputs the cart list information stored in the database to the composition list generator 313. The cart list information can be read from the database by the composition list generator 313 at a necessary timing, although the cart list information and the order described in the shipping list are not necessarily synchronized with each other for the ordered product. Since the cart system transmits the shipment request to the warehouse management system 100 after receiving the order from the customer, all the information corresponding to the order described in the shipment list is included in the cart list information.

### [Composition List Generator 313]

The composition list generator 313 generates a composition list based on the shipping list and the cart list information, and outputs the composition list to the document data generator 320. The composition list generator 313 compares an order described in the shipping list with database information in the cart list, and combines customer information corresponding to the order described in the shipping list with the shipping list to generate a composition list. When doing so, the composition list generator 313 also describes, for each order in the composition list, composition setting information which defines rules for generating a variable document.

The composition list generator 313 can switch the composition setting information according to the shipment timing information described in the shipping list. As illustrated in FIG. 4, the composition setting information is information having a structure including an ID, a setting name, artwork data, and insertion coordinates. FIG. 4 illustrates data with ID 1 and data with ID 2. For example, in the ID: 1 data, a setting name is “September promotion campaign”, artwork data is “September campaign.pdf”, and insertion coordinates are “pattern 1.json”. The artwork data is base data into which variable information is inserted in variable printing, and corresponds to a flyer image of a product in the present embodiment. The insertion coordinates are coordinates into which variable information is to be inserted. A flyer image of a product is stored in advance, for example, in the document data generator 320 which will be described later, in association with the product.

The composition list generator 313 extracts corresponding data in the composition setting information depending on the shipment timing information. For example, when the scheduled shipping date in the shipment timing information for an order in the shipping list is August or early September, a flyer of the “September promotion campaign” is appropriate, and thus the composition list generator 313 determines that the ID: 1 data in the composition setting information is appropriate. In this case, ID: 1 is described in the composition list as the composition setting information for the order.

As described above, in the present embodiment, the composition list generator 313 can select the document data to be printed, that is, the image to be formed on the sheet by switching the artwork data in the composition setting information according to the shipment timing information. As a result, when a flyer of the promotion campaign, a flyer having limited-time information, or the like is used as artwork data, the composition list generator 313 can select artwork data having the detail suitable for the time of shipment of a product.

The composition list generator 313 can also switch the composition setting information according to the customer information described in the cart list. Although not illustrated, the composition setting information can include a setting name, artwork data, and insertion coordinates corresponding to the number of purchases of the product.

### [Shipment Information Database 314]

The shipment information database 314 is a database that stores the shipping list imported by the shipping list importing section 311. The shipment information database 314 outputs the past shipping list information stored in the database in response to a request from the printing list generator 315.

### [Printing List Generator 315]

The printing list generator 315 generates a printing list on the basis of the shipping list. More specifically, the printing list generator 315 determines a subject to be printed from a plurality of orders described in the shipping list on the basis of the shipment timing information included in the shipping list, and generates a printing list. The printing list generator 315 also refers to the past shipping list information stored in the shipment information database 314 and adds it to the printing list. More specifically, the printing list generator 315 determines an order to be printed from the shipment timing information described in the shipping list after the composing processing by a composition execution section 321 (to be described later) is normally completed, and adds the order to be printed at that timing to the printing list. When doing so, the printing list generator 315 refers to the past shipment information in the shipment information database 314, determines the printing order from the shipment timing information, and adds the printing order to the printing list.

### [Document Data Generator 320]

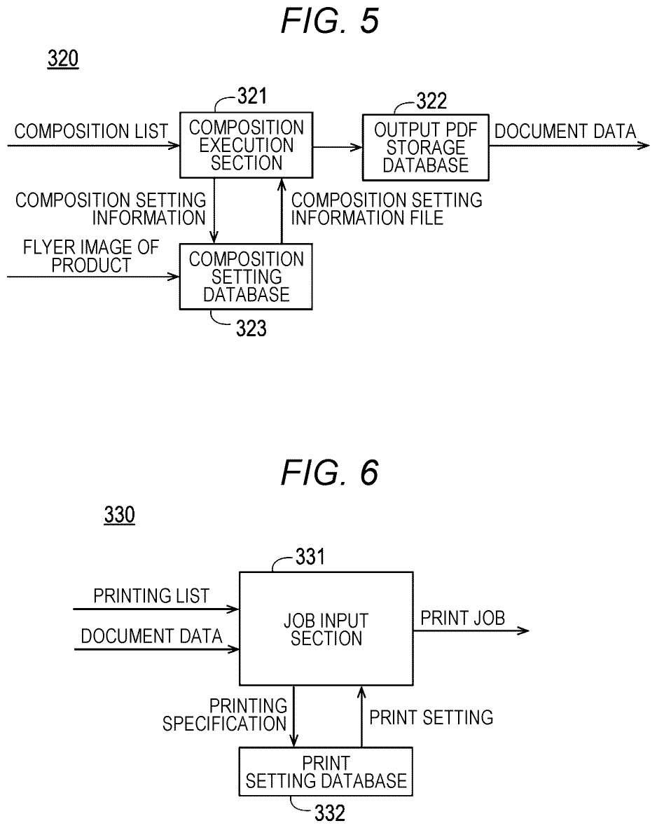

FIG. 5 is a schematic block diagram illustrating the configuration of the document data generator 320 illustrated in FIG. 2. The document data generator 320 generates document data based on the flyer image of a product and the composition list, and outputs the generated document data to the print job generator 330. The document data generator 320 includes the composition execution section 321, an output portable document format (PDF) storage database 322, and a composition setting database 323.

The composition execution section 321 executes composing processing based on the composition list, and generates document data to be printed. The generated document data is saved in the output PDF storage database 322. When performing the composing processing, the composition execution section 321 reads, from the composition setting database 323, information necessary for the composing processing according to the composition setting information. The information necessary for the composing processing is stored in the composition setting database 323. The information necessary for the composing processing includes, for example, a composition setting information file in which the detail of the composition setting information mentioned above is described. The composition setting information file is described in, for example, the JSON format. JSON is an abbreviation for JavaScript Object Notation. The composition setting information file can include an artwork data file serving as a base into which variable information is inserted, an insertion coordinate file indicating coordinates into which the variable information is inserted, image data for insertion, and the like. The insertion coordinate file may also be a JSON file.

### [Print Job Generator 330]

FIG. 6 is a schematic block diagram illustrating the configuration of the print job generator 330 illustrated in FIG. 2. The print job generator 330 generates a print job based on the printing list and the document data and outputs the print job. The generated print job is transmitted to the image forming apparatus 400. The print job generator 330 includes a job input section 331 and a print setting database 332.

The job input section 331 reads the print settings stored in the print setting database 332 on the basis of the printing specifications described in the printing list. The print settings include, for example, the number of pages, the number of copies, the type of sheet (recording medium), the size, the basis weight, single-sided printing/double-sided printing, post-processing (stapling, bookbinding), marking (barcode, QR code), and the like. The job input section 331 generates a print job based on the read print settings and the document data.

### <Image Forming Apparatus 400>

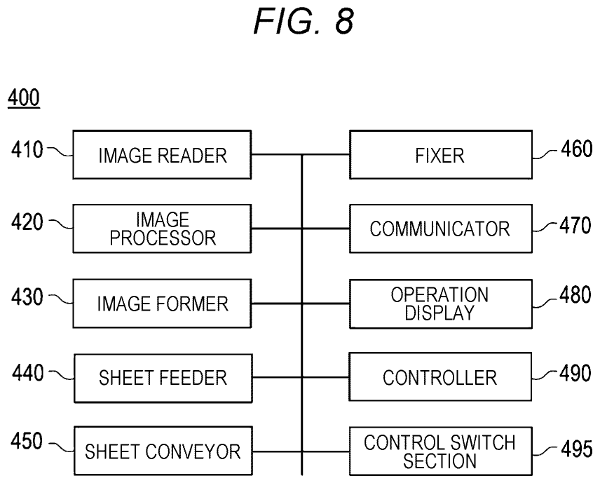

FIGS. 7 and 8 are a configuration diagram and a schematic block diagram illustrating the configuration of the image forming apparatus 400 illustrated in FIG. 1, respectively. The image forming apparatus 400 receives a print job from the printing support system 300 and forms (prints) an image on a sheet (recording medium) 41. The print job includes, for example, print data in a page description language (PDL) format and print settings. The print data includes, for example, data of first to N-th pages. In the present embodiment, the image forming apparatus 400 generates a printed product to be conveyed together with a product.

The image forming apparatus 400 includes an image reader 410, an image processor 420, an image former 430, a sheet feeder 440, a sheet conveyor 450, a fixer 460, a communicator 470, an operation display 480, a controller 490, and a control switch section 495. These constituent elements are connected to one another by an internal bus.

### [Image Reader 410]

The image reader 410 includes an optical system including a mirror, a lens, and the like, and a reading sensor. The image reader 410 reads a document placed on a reading surface or a document conveyed by an auto document feeder (ADF), and outputs an image signal.

### [Image Processor 420]

The image processor 420 generates print image data on the basis of print data and print settings included in the print job received from the printing support system 300 through the communicator 470. More specifically, the image processor 420 analyzes the print job received from the printing support system 300, and performs processing such as color conversion, screening, and rasterization on each page of the print data to generate print image data in a bitmap format. The image processor 420 includes a buffer (memory) that temporarily stores a plurality of print jobs received from the printing support system 300. The image processor 420 also includes an image memory that temporarily stores the generated print image data.

The image processor 420 generates print image data by performing various types of image processing on the image signal received from the image reader 410. The generated print image data is transmitted to the image former 430.

### [Image Forming Section 430]

The image former 430 forms an image on the sheet 41 on the basis of print image data using a known image forming process such as an electrophotographic method including charging, exposing, developing, and transferring. The image former 430 includes a photosensitive drum 431 which is an image bearing member, and a charger 432, an optical writer 433, a developing device 434, a transferer 435, and a cleaning device 438 which are disposed around the photosensitive drum 431.

The photosensitive drum 431 is rotated at a predetermined speed by a drum motor (not illustrated). The charger 432 includes a corona discharge pole disposed around the photosensitive drum 431, and charges the surface of the photosensitive drum 431 with generated ions. The optical writer 433 has a scanning optical device incorporated therein, and exposes the charged photosensitive drum 431 based on the input print image data to reduce the potential of the exposed portion, thereby forming a charge pattern (electrostatic latent image) corresponding to the print image data. The developing device 434 develops the formed electrostatic latent image and visualizes it with toner to form a toner image. The transferer 435 transfers the toner image on the photosensitive drum 431 to the sheet 41. The transferer 435 includes an intermediate transfer belt 436 and a secondary transferer 437. The cleaning device 438 includes a brush roller, a lubricant supplier, a cleaning blade, and a housing that houses these components. The transfer residual toner on the intermediate transfer belt 436 is cleaned by the cleaning blade. The surface of the intermediate transfer belt 436 is coated with a lubricant (lubricant agent) by the lubricant supplier.

### [Sheet Feeding Unit 440]

The sheet feeder 440 supplies the sheet 41 as a recording medium to the image former 430. The sheet feeder 440 includes an upper tray 441 and a lower tray 442, and the trays can store different types of sheets 41 such as plain paper and high-quality paper.

### [Sheet Conveyance Section 450]

The sheet conveyor 450 conveys the sheet 41 in the image forming apparatus 400. The sheet conveyor 450 includes a conveyance path 451 and a plurality of conveyance roller pairs 452 for conveying the sheet 41. Further, the sheet conveyor 450 includes a sheet reversing section 453 that reverses the sheet 41 subjected to fixing by the fixer 460 and ejects the sheet 41. Furthermore, the sheet conveyor 450 is also provided with a circulation conveyor 454 for supplying the sheet 41 subjected to the fixing to the image former 430 again. The controller 490 controls the sheet conveyor 450 to supply the sheet 41 reversed by the sheet reversing section 453 to the image former 430 again by the circulation conveyor 454, thereby forming images on both sides of the sheet 41.

The sheet 41 fed from the sheet feeder 440 is conveyed through the conveyance path 451 toward the image former 430. The sheet 41 is synchronized with the toner image formed on the photosensitive drum 431 at a registration roller pair 455, and a timing at which the sheet 41 is conveyed to the secondary transferer 437 is controlled. The sheet 41 on which the toner image has been transferred by the secondary transferer 437 is conveyed to the fixer 460. Next, the sheet 41 on which the image is fixed by the fixer 460 is conveyed to the circulation conveyor 454 or ejected onto the sheet ejection tray 456.

### [Fixing Unit 460]

The fixer 460 fixes a toner image formed on the sheet 41. The fixing section 460 includes a hollow heating roller having a heater disposed therein and a pressure roller facing the heating roller. The heating roller and the pressure roller are controlled by the heater to a predetermined temperature set according to the sheet type, and apply heat and pressure to the sheet 41 to fix the toner image. A correspondence relationship between the sheet type and the fixing temperature is held in a sheet profile (hereinafter, also simply referred to as a “profile”).

The profile is generated based on a plurality of types of attributes for setting image formation conditions. The profile is a file in which set values of various image formation conditions for performing optimum printing are described for each attribute of the sheet 41. In the profile, for example, set values such as a fixing temperature at the fixer 460 and correction of an image to be printed are described for the type (sheet type) of the sheet 41 as the attribute of the sheet 41. For example, the profile describes image formation conditions such as a fixing temperature T1° C. for plain paper and a fixing temperature T2° C. for high-quality paper. Furthermore, the set values in the profile are held in association with the sheet feed trays of the sheet feeder 440 for each sheet type. For example, the set values of the fixing temperature for plain paper and high-quality paper are associated with the upper tray 441 and the lower tray 442, respectively. That is, the fixing temperature for plain paper is applied to the sheet supplied from the upper tray 441, and the fixing temperature for high-quality paper is applied to the sheet supplied from the lower tray 442.

### [Communication Unit 470]

The communicator 470 is connected to, for example, a client terminal via a communication line and transmits and receives data such as jobs.

### [Operation Display Unit 480]

The operation display 480 includes an input section and an output section (which are not illustrated). The input unit includes, for example, a keyboard and a touch screen and is used for an operator to perform various instructions (inputs) such as character input, various settings, and a start instruction. The output section includes a display, and is used to present, to the worker, a device configuration, an execution status of a job, post-processing executable conditions, an output image, an occurrence status of abnormality (jam) in sheet conveyance, and the like.

### [Controller 490]

The control unit 490 controls the image reading unit 410, the image processing unit 420, the image forming unit 430, the sheet feeding unit 440, the sheet conveying unit 450, the fixing unit 460, the communication unit 470, and the operation display unit 480.

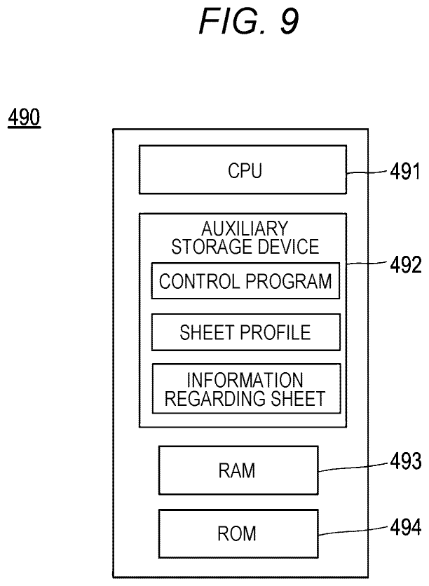

FIG. 9 is a schematic block diagram illustrating the configuration of the controller 490 illustrated in FIG. 8. The controller 490 includes a CPU 491, an auxiliary storage device 492, a RAM 493, and a ROM 494.

The CPU (hardware processor) 491 controls each section of the image forming apparatus 400 by executing a control program for the image forming apparatus. The control program is stored in the auxiliary storage device 492 and is loaded onto the RAM 493 when the program is executed by the CPU 491. The auxiliary storage device 492 includes, for example, a large-capacity storage section device such as a hard disk drive and a flash memory.

The auxiliary storage device 492 also stores, in addition to the various programs, a sheet profile, information (hereinafter, also referred to as “sheet-related information) regarding the sheet 41 on which a document is printed by the image former 430, product information, customer information, and the like. The sheet-related information is information related to a document to be printed on the sheet 41 by the image former 430 and the sheet 41 on which the document is to be printed, and can be saved in the auxiliary storage device (storage) 492 in association with at least one of product information and customer information. The sheet-related information may be, for example, information including a combination of the file name of the document and the size and type of the sheet 41 on which the document is to be printed.

The RAM 493 stores a calculation result or the like accompanied by the execution of the CPU 491. The ROM 494 stores various parameters, various programs, and the like. The CPU 491 realizes various functions by executing a control program for the image forming apparatus.

In the present embodiment, the controller 490 executes the control program to control the formation of the image by the image former 430 based on the attribute of the sheet 41. The details of a method for controlling image formation by the image former 430 will be described later.

### [Control Switch Section 495]

The control switch section 495 includes a DIP switch for switching a cleaning operation mode. The DIP switch is disposed, for example, on a back surface or the like of a housing of the image forming apparatus 400, and is configured to be accessible by a user as necessary.

In the present embodiment, as illustrated in the following Table 1, the cleaning operation mode includes two modes, a cleaning operation ON mode (first mode) and a cleaning operation OFF mode (second mode), which can be switched by the DIP switch. The DIP switch functions as a setter for setting or switching the cleaning operation mode.

TABLE 1

| DIP switch | Detail (mode) |
|---|---|
| 0 (default) | Cleaning operation ON |
| 1 | Cleaning operation OFF |

The DIP switch is set to 0 by default, and at this time, the cleaning operation is turned on. When the DIP switch is set to 1, the cleaning operation is turned off.

Note that the case where the cleaning operation mode is switched using the DIP switch has been described, but the present invention is not limited to such a case, and the cleaning mode may be switched by software.

In a case where, during continuous image formation on a plurality of sheets, there is dirt remaining on the intermediate transfer belt 436 after an image is formed on a preceding sheet having a sheet width smaller than the sheet width of the subsequent sheet, the end of the subsequent sheet in the sheet width direction, particularly the leading end of the sheet, may be contaminated. The sheet width refers to the length (size) of the sheet 41 in a direction orthogonal to the conveyance direction of the sheet 41.

In the present embodiment, in the cleaning operation ON mode, the controller 490 causes the cleaning device 438 to clean the intermediate transfer belt 436 by controlling the cleaning device 438 in a case where images are successively printed on the sheet 41 and a sheet having a sheet width greater than that of the sheet 41. On the other hand, the controller 490 does not perform the control to clean the intermediate transfer belt 436 in the cleaning operation OFF mode. For example, the controller 490 does not issue a cleaning instruction to the cleaning device 438 in the cleaning operation OFF mode.

In a case where, during the successive image formation on a plurality of sheets, the sheet width of the subsequent sheet is greater than that of the preceding sheet, the dirt on the intermediate transfer belt 436 due to the image formation on the preceding sheet can be removed by cleaning. On the other hand, if the intermediate transfer belt 436 is not cleaned after the image formation of the preceding sheet, the intermediate transfer belt 436 may remain dirty. However, in a case where the contamination of the sheet is not problematic, such as a case where it is sufficient that printed content can be confirmed even if the subsequent sheet is contaminated, the cleaning operation is turned off, by which the productivity of printed materials obtained by continuously forming images on a plurality of sheets can be improved.

### <Method for Printing Leaflet in EC System>

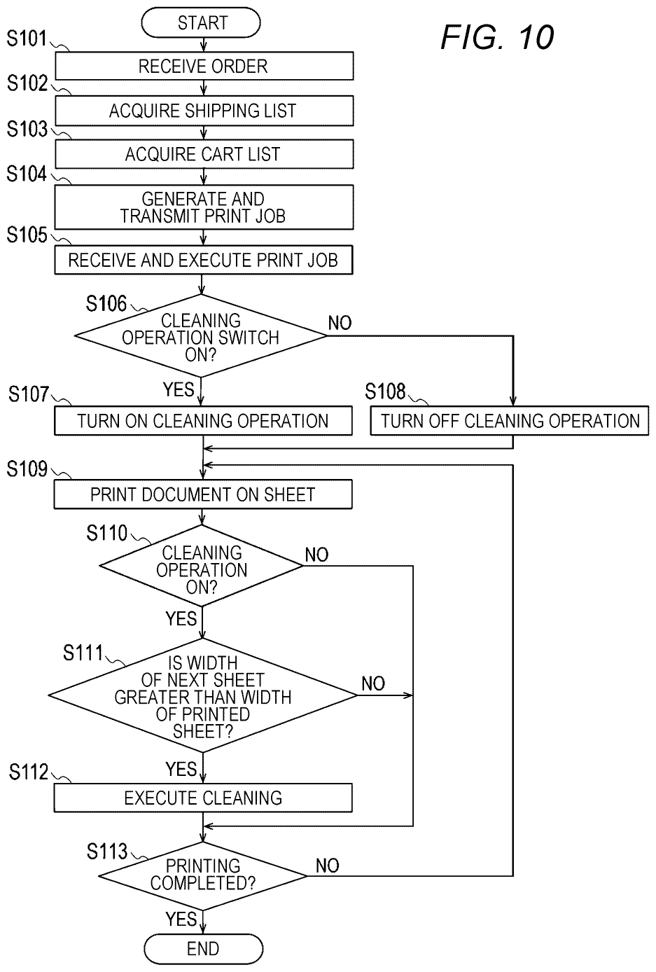

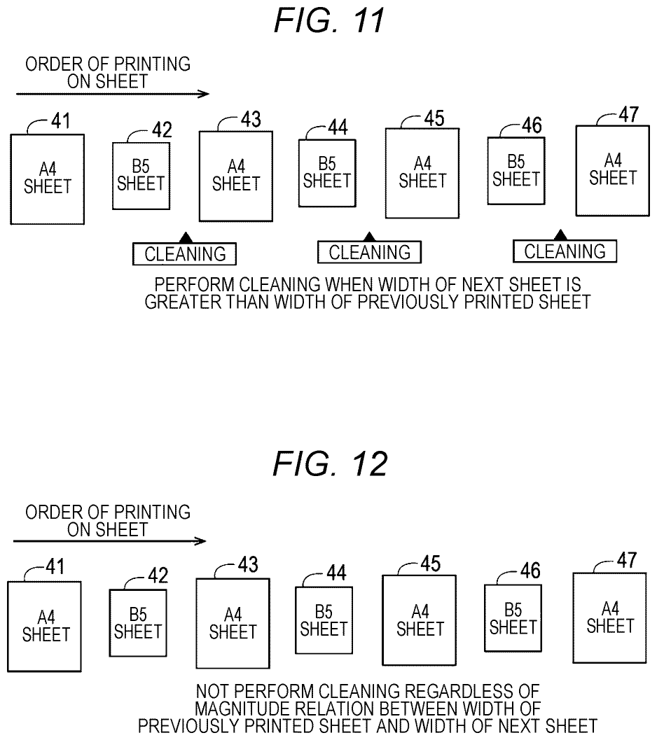

FIG. 10 is a flowchart illustrating the procedure of a method for printing a flyer in the image forming system 500 according to the first embodiment. FIG. 11 is a schematic diagram illustrating an operation of continuously printing images on sheets having different widths when the cleaning operation is on, and FIG. 12 is a schematic diagram illustrating an operation of continuously printing images on sheets having different widths when the cleaning operation is off.

Hereinafter, a case where the customer orders the commodity a1 of the company A will be exemplified. The same applies to a case where the customer orders another product of the A company or a product of the B company or the C company. The process of step S101 in FIG. 10 is implemented by the server 21 of the company A. In addition, the processes of steps S102 to S104 in FIG. 10 are implemented by the server of the EC specialized logistics center 30. Furthermore, the processes of steps S105 to S113 in FIG. 10 are implemented by the CPU 491 of the image forming apparatus 400 executing the control program.

First, the customer operates the customer terminal 10 to place an order for the product a1 on the EC site of the company A. The customer terminal 10 transmits ordering information to the cart system of the company A. The ordering information may include, for example, information such as an order date and time of the item a1, an item name, a quantity, a customer's name, address, contact information, a delivery destination name, and a delivery destination address.

The cart system of the company A receives the order (step S101), and generates product information about the product a1 and the customer information based on the received ordering information and the production information (e.g., the serial number, the date of manufacture, the manufacturing line, etc.) about the product a1. The cart system of the company A outputs a cart list including the product information and the customer information to the warehouse management system 100 and the printing support system 300.

Upon receiving the shipping instruction, the warehouse management system 100 generates a management number and creates a shipping list of the item, based on the cart list and the information on the inventory item acquired from the warehouse 200.

Next, the print information acquirer 310 acquires a shipping list (step S102). More specifically, the shipping list importing section 311 imports the shipping list and transmits the imported shipping list to the composition list generator 313 and the shipment information database 314. The shipping list is stored in the shipment information database 314.

Next, the print information acquirer 310 acquires a cart list (step S103). The acquired cart list is saved in the cart list database 312.

The composition list generating section 313 generates a composition list based on the shipping list and the cart list information, and outputs the composition list to the document data generating section 320. The document data generator 320 generates document data on the basis of a composition list and a composition setting information file stored in the composition setting database 323. The printing list generator 315 generates a printing list. Next, the print job generator 330 generates a print job based on the printing list and the document data and transmits the generated print job to the image forming apparatus 400 (step S104).

The print job generator 330 also generates a print job based on the printing list and transmits the generated print job to the image forming apparatus 400.

Next, the image processor 420 receives the print job through the communicator 470 and stores the print job in the buffer. The image processor 420 executes the print job stored in the buffer (step S105).

Next, the controller 490 checks whether or not the cleaning operation switch is on (step S106). More specifically, the controller 490 checks the state of the DIP switch of the control switch section 495. When the cleaning operation switch is on, that is, when the DIP switch is 0 (YES in step S106), the controller 490 turns on the cleaning operation (step S107). On the other hand, when the cleaning operation switch is off, that is, when the DIP switch is 1 (NO in step S106), the controller 490 turns off the cleaning operation (step S108). In the present embodiment, the case where the cleaning operation is on corresponds to the first mode, and the case where the cleaning operation is off corresponds to the second mode. The first mode is a mode in which cleaning of the intermediate transfer belt 436 is performed in a case where, subsequent to the formation of an image on a sheet (first recording medium) having a first size as the sheet width thereof, an image is formed on a sheet (second recording medium) having, as the sheet width, a second size greater than the first size. The second mode is a mode in which the cleaning of the intermediate transfer belt 436 is not performed in a case where, subsequent to the formation of an image on the sheet having the first size as the sheet width thereof, an image is formed on the sheet having, as the sheet width, the second size greater than the first size.

Next, the image former 430 prints the document on the sheet (step S109). The controller 490 controls the image forming section 430 so as to form an image on a sheet based on the print image data generated by the image processing section 420.

Next, the controller 490 checks whether or not the cleaning operation switch is on (step S110). When the cleaning operation is on (YES in step S110), the controller 490 determines whether or not the next sheet is wider than the previously printed sheet (step S111). That is, the controller 490 determines whether or not there is a change in the width (attribute) of the sheet. For example, as illustrated in FIG. 11, when a next sheet 43 is wider than a previously printed sheet 42 (YES in step S111), the controller 490 causes the cleaning device 438 to execute cleaning of the intermediate transfer belt 436 (step S112). Then, the controller 490 determines whether or not the printing is completed (step S113). Similarly, after printing an image onto a sheet 44, the controller 490 causes the cleaning device 438 to execute cleaning of the intermediate transfer belt 436 because the width of a next sheet 45 is greater than the width of the previously printed sheet 44. Furthermore, cleaning of the intermediate transfer belt 436 is also performed after printing an image onto a sheet 46. Next, as in the example illustrated in FIG. 11, in a case where the print job includes images for seven pages and printing of the sheet 47 is completed, the controller 490 ends the processing for the print job. When the printing of the sheet 47 is not completed, the processing returns to step S109.

On the other hand, as illustrated in FIG. 12, when the cleaning operation is not on, that is, when the cleaning operation is off (NO in step S110), the controller 490 does not perform cleaning after printing of each sheet, regardless of the magnitude relation between the width of the previously printed sheet and the width of the next sheet. Then, the controller 490 moves to a process of determining whether or not the printing has been completed (step S113). Further, even when the cleaning operation is on (YES in step S110), the controller 490 also moves to the process (step S113) of determining whether or not the printing has been completed without performing the cleaning in a case where the next sheet is not wider than the previously printed sheet (NO in step S111). That is, when the width of the next sheet and the width of the previously printed sheet are equal to each other or the width of the next sheet is smaller than the width of the previously printed sheet, the controller 490 ends the processing for the print job without performing cleaning.

As described above, in the present embodiment, only when the cleaning operation is on and the width of the next sheet is greater than the width of the previously printed sheet, the cleaning of the intermediate transfer belt 436 is executed, and in other cases, the cleaning is not performed. That is, the controller 490 executes, in the first mode, control (cleaning of the intermediate transfer belt 436) based on a change in the width (attribute) of the sheet. On the other hand, the controller 490 does not perform the control (cleaning of the intermediate transfer belt 436) based on a change in the width (attribute) of the sheet in the second mode.

(Example of Pattern Table for Leaflet to be Packed with Product)

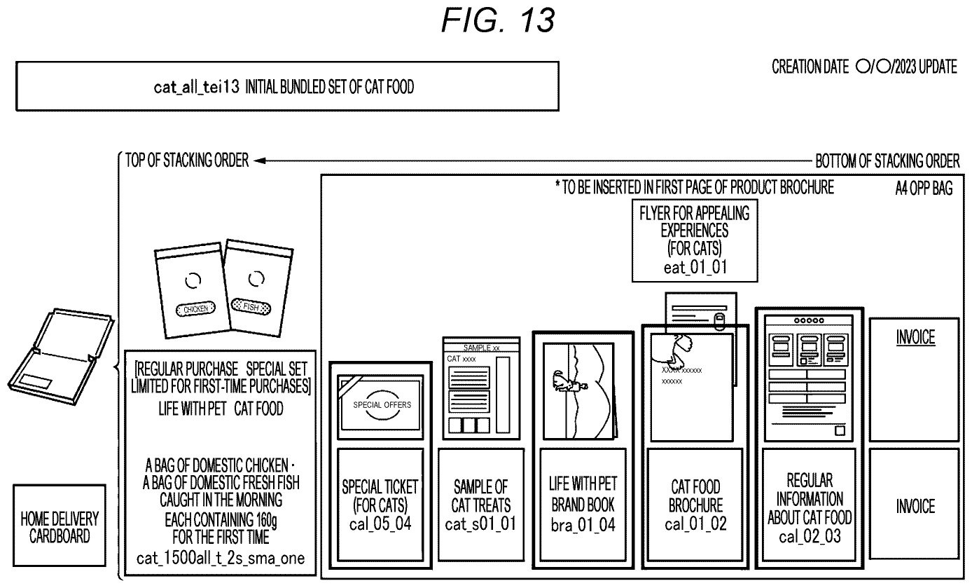

FIG. 13 is a schematic diagram illustrating a pattern table of a leaflet to be packed with a product. The pattern table is a table which shows an image of a flyer for each page, a description of the image, a file name, and the stacking order of the pages. FIG. 19 illustrates a pattern table for a flyer bundled with cat food. The pattern table in FIG. 19 illustrates that the flyer is bundled with the product at the time of the first regular purchase and is sent to the customer.

### (Current Shipping Operation as Comparative Example)

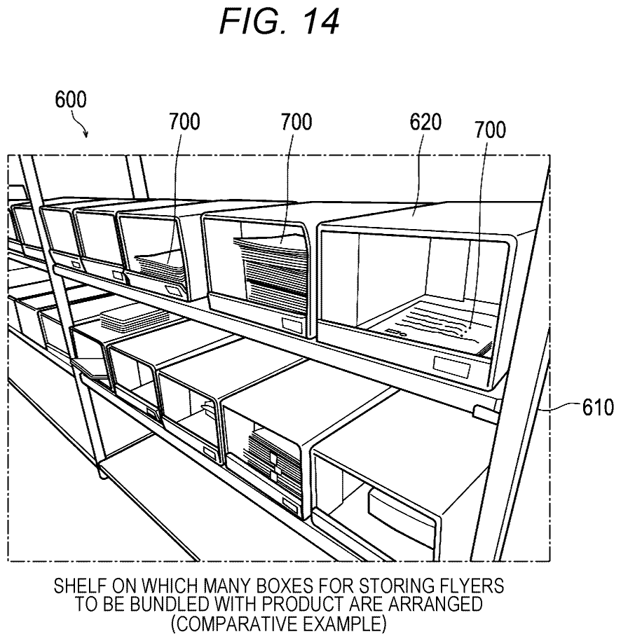

FIG. 14 is a schematic diagram illustrating a shelf 610 on which many boxes 620 for storing the flyers 700 are arranged. At present, a shelf 610 is installed in a leaflet storage place 600 of an EC-specialized distribution center 30, and a large number of boxes 620 for storing leaflets 700 are arranged side by side on the shelf 610. The worker picks a flyer 700 from the shelf 610 on which the corresponding flyer 700 is placed according to a product to be sent and packages the flyer 700 together with the product when shipping the product.

However, the flyer 700 to be bundled with a product has various patterns depending on the product, regular purchase, the number of purchase, and the like. In addition, when there are a plurality of flyers 700 to be bundled with the product, the stacking order is also usually designated by the brand owner in advance. The worker manually picks the flyer 700 while looking at the pattern table of the flyer 700. Picking of the leaflet 700 is performed manually, so that a mistake tends to occur.

As described above, under the current situation, a worker creates a set of flyers 700 in advance in his/her spare time for each purchased product or for each number of purchases, for example, and when picking a product, the worker also picks the created set of flyers 700. However, there is a case where a flyer 700 to be bundled with a product is changed depending on products, regular purchases, the number of purchases, or the like. In addition, a flyer 700 to be bundled may be frequently changed depending on the season, a model change of products, or the like. In such a case, the amount of work of the worker at the site where the product is shipped increases. Further, in such a case, flyers 700 which cannot be used have to be discarded, although the flyers 700 which can be used even after the change may be extracted from the set and used.

### (Effect of Image Forming System 500 According to Present Embodiment)

The image forming system 500, the method for controlling the image forming system 500, and the control program according to the present embodiment have the following effects.

In the image forming system 500, the time for generating the printed material to be sent together with the product is shortened, whereby the productivity of the printed material is improved, and the provision of the printed material can be expedited. Therefore, it is possible to prevent or reduce the delay of the shipping work for the product and the printed material. Thus, the printed material such as the flyer can be generated according to the schedule of the shipping work.

### Second Embodiment

The first embodiment has described the image forming system 500 having the cleaning operation ON mode in which the control of the execution of the cleaning is performed based on a change in the sheet width as the attribute of the sheet and the cleaning operation OFF mode in which the control of the execution of the cleaning based on a change in the sheet width is not performed.

The second embodiment will describe an image forming system 500 having a fixing temperature control ON mode in which control of a fixing temperature based on a sheet type as an attribute of a sheet is performed and a fixing temperature control OFF mode in which control of a fixing temperature based on a sheet type is not performed.

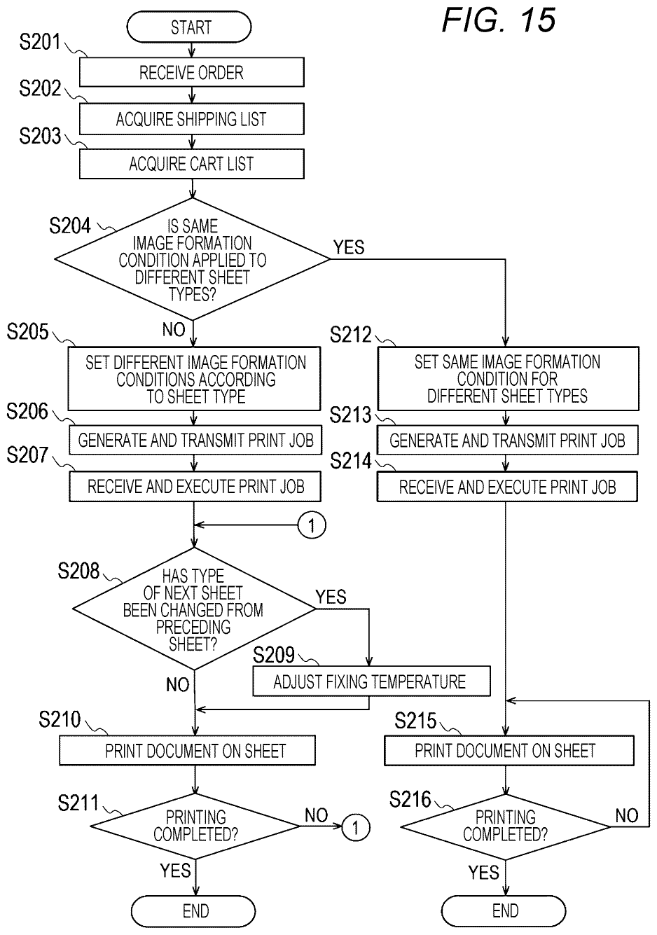

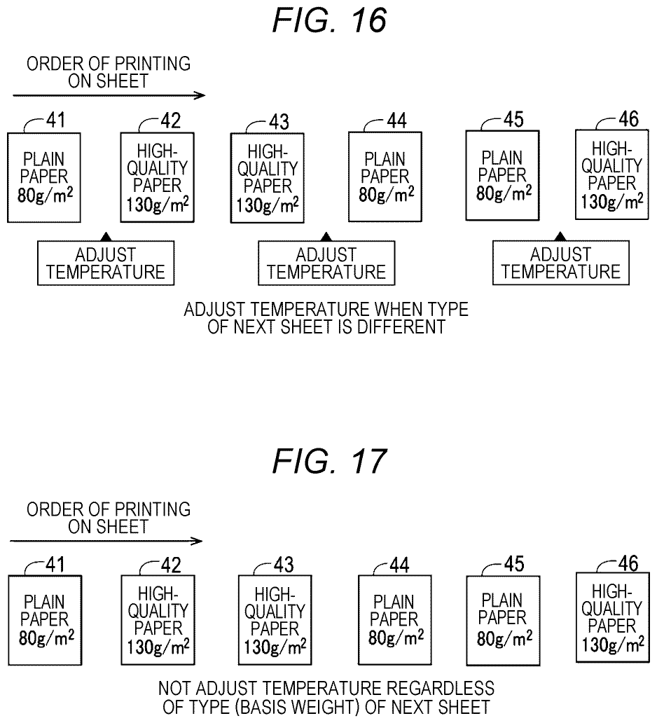

FIG. 15 is a flowchart illustrating the procedure of a method for printing a flyer by the image forming system 500 according to the second embodiment. FIG. 16 is a schematic diagram illustrating an operation of continuously printing images on sheets of different types (basis weights) in the fixing temperature control ON mode, and FIG. 17 is a schematic diagram illustrating an operation of continuously printing images on sheets of different types (basis weights) in the fixing temperature control OFF mode.

Hereinafter, a case where the customer orders the commodity a1 of the company A will be exemplified. The same applies to a case where the customer orders another product of the A company or a product of the B company or the C company. The process of step S201 in FIG. 15 is implemented by a server 21 of the company A. In addition, the processes of steps S202, S203, S206, and S213 in FIG. 15 are implemented by a server of an EC specialized logistics center 30. Furthermore, the processes of steps S204, S205, S207 to S211, S212, and S214 to S216 in FIG. 15 are implemented by a CPU 491 of an image forming apparatus 400 executing a control program. In order to avoid duplication of description, description of the same configuration as that of the first embodiment will be omitted or simplified. The processes of steps S201 to S203, S206, S207, S210, and S211 are the same as the processes of steps S101 to S103, S104, S105, S109, and S113 in the first embodiment, and thus, will not be described in detail. Furthermore, the processes of steps S213 to S216 are the same as the processes of steps S206, S207, S210, and S211, respectively, and thus will not be described in detail.

### (Steps S204 and S205)

The controller 490 determines whether or not to apply the same image formation condition to different sheet types in the profile. Whether or not to apply the same image formation condition to different sheet types may be stored in an auxiliary storage device 492 in advance, or may be input by a user through an operation display 480. The case where the same image formation condition is not applied to different sheet types corresponds to the fixing temperature control ON mode (first mode), and the case where the same image formation condition is applied to different sheet types corresponds to the fixing temperature control OFF mode (second mode). The image forming system 500 is switched to the fixing temperature control ON mode or the fixing temperature control OFF mode.

When the same image formation condition is not applied to different sheet types (NO in step S204), the controller 490 sets different image formation conditions according to the sheet type in the profile (step S205). In general, the basis weight varies depending on the sheet type. For example, while the basis weight of plain paper is about 80 g/m², the basis weight of high-quality paper is about 130 g/m². That means the basis weight of high-quality paper is greater than that of plain paper. Since it is necessary to increase the fixing temperature as the basis weight is greater, the fixing temperature for high-quality paper is set higher than the fixing temperature for plain paper in normal fixing temperature control.

### (Steps S208 and S209)

The controller 490 determines whether or not the type of the next sheet has been changed from the previous sheet (step S208). When the type of the next sheet has been changed from the previous sheet (YES in step S208), the controller 490 adjusts the fixing temperature (step S209). In the fixing temperature control ON mode, the controller 490 performs control to change (adjust) the fixing temperature in a case where images are successively formed on sheets having different basis weights. For example, as illustrated in FIG. 16, the controller 490 performs control to increase the fixing temperature in a case where an image is formed on a sheet 42 having, as a basis weight, a second value (about 130 g/m²) greater than a first value (80 g/m²) as a basis weight of a sheet 41. The same applies to a case where the image formation on a sheet 46 is performed after the image formation on a sheet 45. In addition, the controller 490 performs control to decrease the fixing temperature in a case where an image is formed on a sheet 44 having, as a basis weight, the second value (about 80 g/m²) smaller than the first value (130 g/m²) as a basis weight of a sheet 43.

In this way, when an image is fixed onto a sheet, the image is fixed at an appropriate fixing temperature set according to the basis weight of the sheet, whereby a printed material having a high-quality image with little deformation such as curling in the sheet after fixing is obtained. On the other hand, when the type of the next sheet has not been changed from the preceding sheet (NO in step S208), the controller 490 does not change the fixing temperature. The controller 490 does not perform the control of changing the fixing temperature in a case where images are successively formed on sheets having the same basis weight. In FIG. 16, the case where images are successively formed on sheets having the same basis weight includes the case where an image is formed on the sheet 43 after the image formation on the sheet 42 and the case where an image is formed on the sheet 45 after the image formation on the sheet 44.

### (Steps S204 and S212)

On the other hand, when applying the same image formation condition to different sheet types in the profile (YES in step S204), the controller 490 sets the same profile for the different sheet types in the profile (step S212). For example, the controller 490 sets the same fixing temperature as an image formation condition for both plain paper and high-quality paper. More specifically, the same fixing temperature is set for an upper tray 441 and a lower tray 442. For example, a fixing temperature used for high-quality paper is applied to both plain paper and high-quality paper.

As illustrated in FIG. 17, in the fixing temperature control OFF mode, the controller 490 does not perform the control to change the fixing temperature not only in the case where the images are successively formed on the sheets having the same basis weight but also in the case where the images are successively formed on the sheets having different basis weights. For example, in a case where an image is printed on plain paper just after an image is printed on high-quality paper, the controller 490 performs control such that the fixing temperature is maintained at the fixing temperature for the high-quality paper without being decreased to the temperature normally used for the fixing of the plain paper. In addition, in a case where an image is printed on high-quality paper just after an image is printed on plain paper, the controller 490 performs control such that the fixing temperature is maintained at the fixing temperature for the plain paper without being increased to the temperature normally used for the fixing of the high-quality paper.

In a case where the same fixing temperature is applied to different sheet types, the sheets may be deformed, or the image quality may be reduced. However, in a case where the quality of the printed material is not problematic, such as a case where it is sufficient that printed content can be confirmed, the fixing temperature control is turned off, by which the productivity of printed materials obtained by successively forming images on a plurality of sheets can be improved. Therefore, it is possible to prevent or suppress the delay of the shipping work of the product and the printed matter. Thus, the printed matter such as the leaflet can be generated according to the schedule of the shipping work.

As described above, the image forming system 500, the method for controlling the image forming system 500, and the control program have been described in the embodiment. However, it is needless to say that those skilled in the art can appropriately add, modify, and omit the present invention within the scope of the technical idea thereof.

For example, the printing support system 300 may generate a cover letter, an invoice, or a flyer in combination with the input shipping list or information stored in the cart list database 312 or the like in advance without using document data (for example, PDF format) created in advance.

Furthermore, the control program may be provided by a computer-readable recording medium, such as a USB memory, a flexible disk, or a CD-ROM, or may be provided online via a network, such as the Internet. In this case, the control program recorded on the non-transitory computer-readable storage medium is usually transferred to and stored in a memory, a storage, or the like. Furthermore, this control program may be provided, for example, as independent application software, or may be incorporated, as one function of the server, into software of each apparatus.

While the embodiments of the present invention have been described and illustrated in detail, the disclosed embodiments have been created for purposes of illustration and example only, and not limitation. The scope of the present invention should be interpreted by the wording of the accompanying claims.

What is claimed is:

1. An image forming system comprising:
an image former that forms an image on a recording medium; and
a hardware processor that controls image formation by the image former on the basis of an attribute of the recording medium,
the image forming system having a first mode in which control based on a change in the attribute of the recording medium is performed and a second mode in which the control based on a change in the attribute of the recording medium is not performed, in a case where image formation on a first recording medium having a first attribute and image formation on a second recording medium having a second attribute different from the first attribute are continuously performed.

2. The image forming system according to claim 1, wherein
an image forming job for generating a printed material to be sent together with a product includes image formation on the first recording medium and image formation on the second recording medium, and information regarding the image formed by the image former and the recording medium is stored in a storage in association with information regarding the product.

3. The image forming system according to claim 1, wherein
the attribute of the recording medium includes a size of the recording medium in a direction orthogonal to a direction in which the recording medium is conveyed, and
the control based on a change in the attribute of the recording medium includes cleaning a transferer for transferring the image onto the recording medium.

4. The image forming system according to claim 3, wherein
the first mode is a mode in which the transferer is cleaned in a case where, subsequent to image formation on a recording medium having a first size as the size of the recording medium, image formation is performed on a recording medium having, as the size of the recording medium, a second size greater than the first size, and
the second mode is a mode in which the transferer is not cleaned in a case where, subsequent to image formation on the recording medium having the first size as the size of the recording medium, image formation is performed on the recording medium having, as the size of the recording medium, the second size greater than the first size.

5. The image forming system according to claim 1, wherein
the attribute of the recording medium includes a basis weight of the recording medium, and
the control based on a change in the attribute of the recording medium includes changing a temperature of a fixer for fixing the image on the recording medium.

6. The image forming system according to claim 5, wherein
the first mode is a mode in which control for decreasing the temperature of the fixer is performed in a case where, subsequent to image formation on a recording medium having a first value as the basis weight, image formation is performed on a recording medium having, as the basis weight, a second value smaller than the first value, and
the second mode is a mode in which the control for decreasing the temperature of the fixer is not performed in a case where, subsequent to image formation on the recording medium having the first value as the basis weight, image formation is performed on the recording medium having, as the basis weight, the second value smaller than the first value.

7. The image forming system according to claim 5, wherein
the first mode is a mode in which control for increasing the temperature of the fixer is performed in a case where, subsequent to image formation on a recording medium having a first value as the basis weight, image formation is performed on a recording medium having, as the basis weight, a second value greater than the first value, and
the second mode is a mode in which the control for increasing the temperature of the fixer is not performed in a case where, subsequent to image formation on the recording medium having the first value as the basis weight, image formation is performed on the recording medium having, as the basis weight, the second value greater than the first value.

8. The image forming system according to claim 1, further comprising a setter for setting the first mode and the second mode.

9. The image forming system according to claim 2, wherein
a sheet profile generated based on a plurality of types of attributes for setting an image formation condition and a tray for accommodating sheets are stored in association with each other, and
the hardware processor sets a same image formation condition for different attributes in the sheet profile.

10. A control method for controlling an image forming system including an image former that forms an image on a recording medium, and a hardware processor that controls image formation by the image former on the basis of an attribute of the recording medium, the control method comprising
switching an operation mode of the image forming system between a first mode in which control based on a change in the attribute of the recording medium is performed and a second mode in which the control based on a change in the attribute of the recording medium is not performed, in a case where image formation on a first recording medium having a first attribute and image formation on a second recording medium having a second attribute different from the first attribute are continuously performed.

11. A non-transitory computer-readable storage medium storing a control program for controlling an image forming system including an image former that forms an image on a recording medium, and a hardware processor that controls image formation by the image former on the basis of an attribute of the recording medium, the control program causing the hardware processor to execute
switching an operation mode to a first mode in which control based on a change in the attribute of the recording medium is performed and a second mode in which the control based on a change in the attribute of the recording medium is not performed, in a case where image formation on a first recording medium having a first attribute and image formation on a second recording medium having a second attribute different from the first attribute are continuously performed.
